(19) United States
(12) Patent Application Publication
(10) Pub. No.: US 2015/0097960 A1
(43) Pub. Date: Apr. 9, 2015

(54) OPTICAL RELAY SYSTEM AND METHOD

(71) Applicant: MIL-SPEC DESIGNS, LLC, Weatherford, TX (US)

(72) Inventor: Matthew H. Jones, Weatherford, TX (US)

(21) Appl. No.: 14/508,440

(22) Filed: Oct. 7, 2014

Related U.S. Application Data
(60) Provisional application No. 61/887,598, filed on Oct. 7, 2013.

(51) Int. Cl. H04N 7/18; H04N 5/232; G02B 23/14

(52) U.S. Cl. CPC H04N 7/185; G02B 23/14; H04N 5/23229
USPC 348/158

(57) ABSTRACT

An optical relay system including a remote telescopic image capture device for mounting on a telescopic sight that splits off the image viewed through said sight. A camera sensor converts the split off viewed image into a corresponding electrical signal. An image processor conditions the electrical signal for the transmission via RF, and a RF transceiver transmits the signal wirelessly to a remote hand-held device including a display for receiving the transmitted signal, processing and reconstructing the viewed image and displaying it to show what is being viewed through the telescopic sight.

The present invention relates to an optical relay method and system consisting of a remote telescopic image capture device that can be attached or mounted to one or more telescopic sights, a weapon mounted or non-weapon mounted telescopic sight. The telescopic image capture device transmits its viewable image to a remote hand-held device that allows the viewer of the hand-held device to see what the image is that is being viewed through the telescopic device.

The system and method will be described in detail in the following in conjunction with the appended drawings in which:

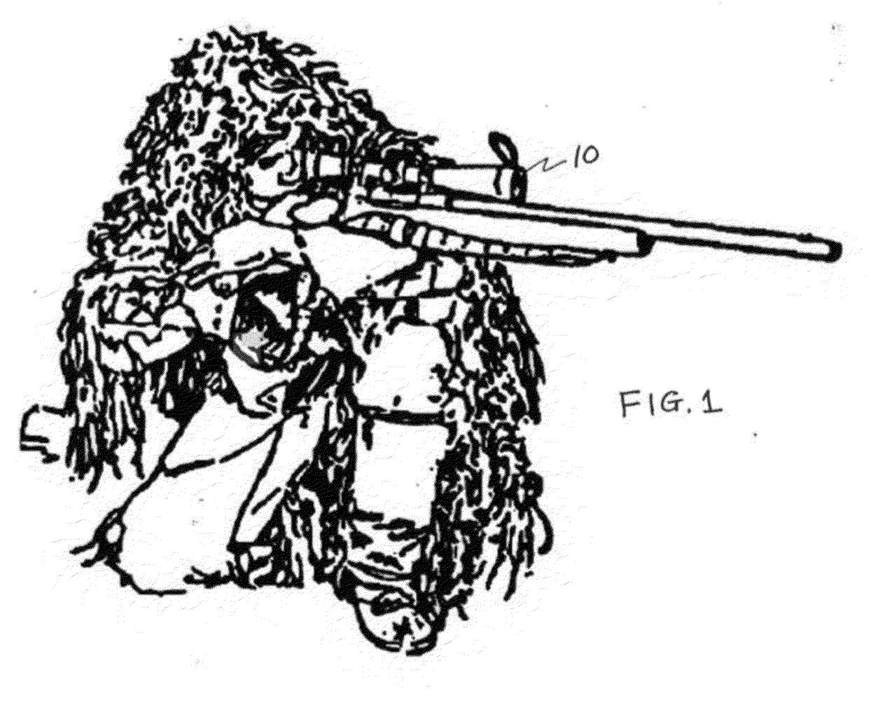

FIG. 1 shows in a schematic view a sniper in camouflage aiming a weapon containing a telescopic sight 10.

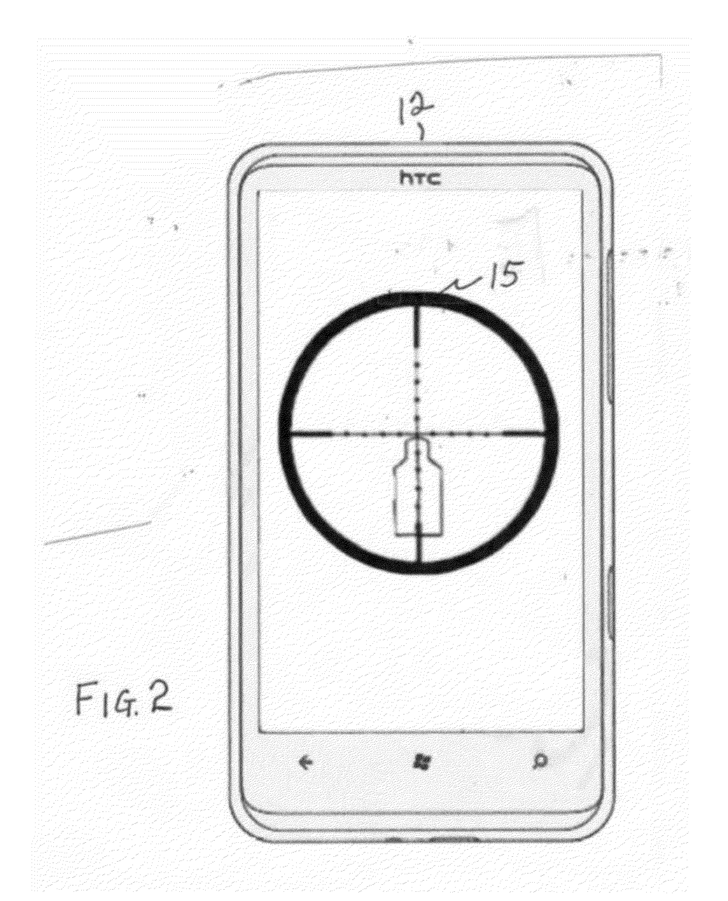

FIG. 2 shows in a schematic view the screen of a hand-held device, like a mobile phone, on which is displayed the image seen through the telescopic sight of FIG. 1.

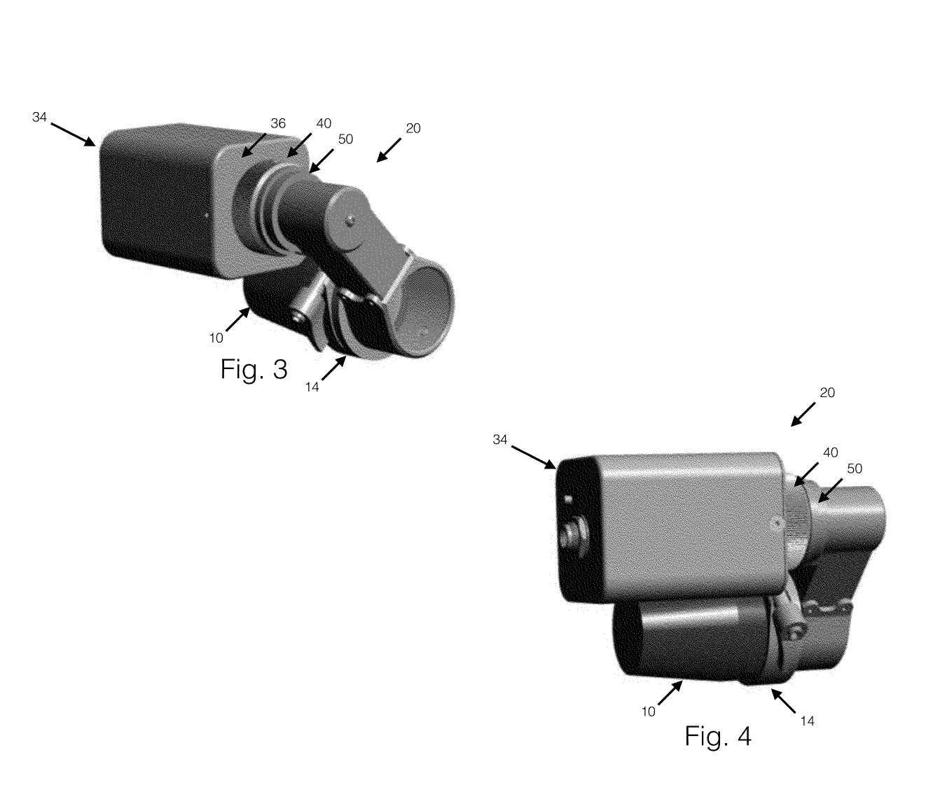

FIG. 3 shows in a perspective view a telescopic image capture device 20 seen from the rear.

FIG. 4 shows in a perspective view the telescopic image capture device 20 seen from the side.

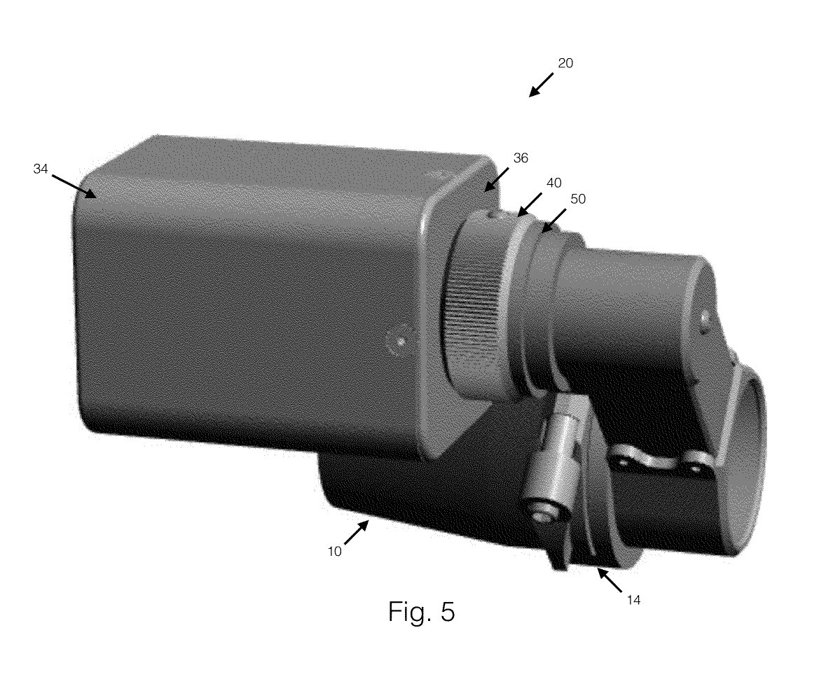

FIG. 5 shows in a perspective view the telescopic image capture device 20 seen from the side and enlarged.

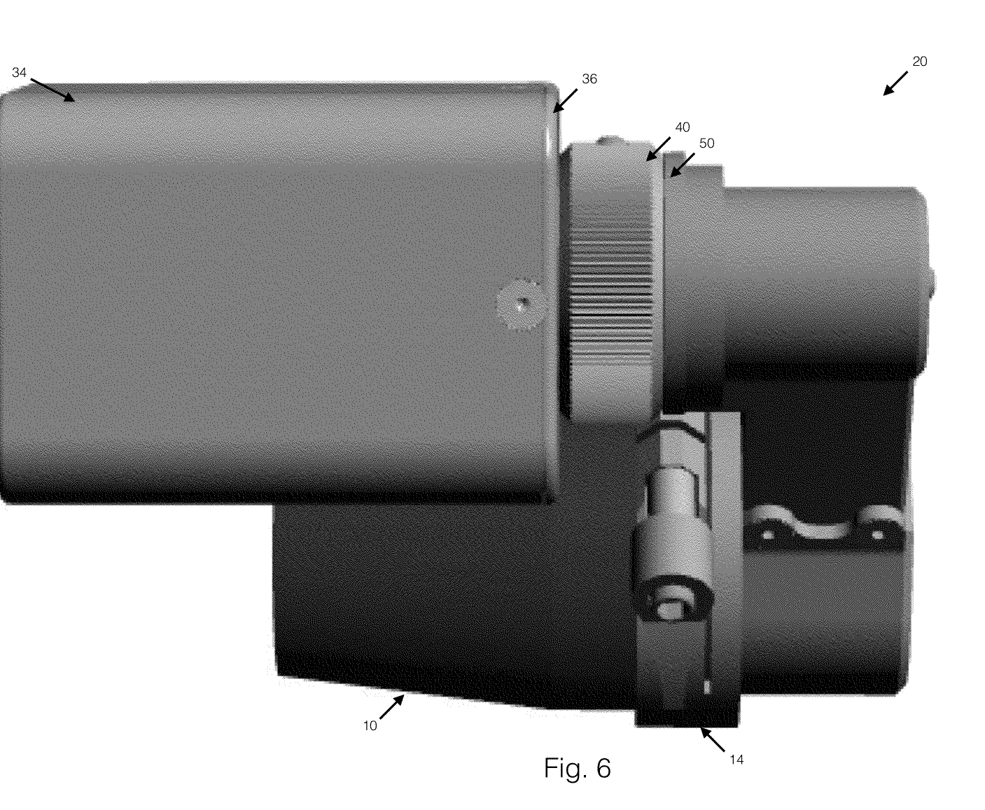

FIG. 6 shows in a side view the telescopic image capture device 20 seen from the side and further enlarged.

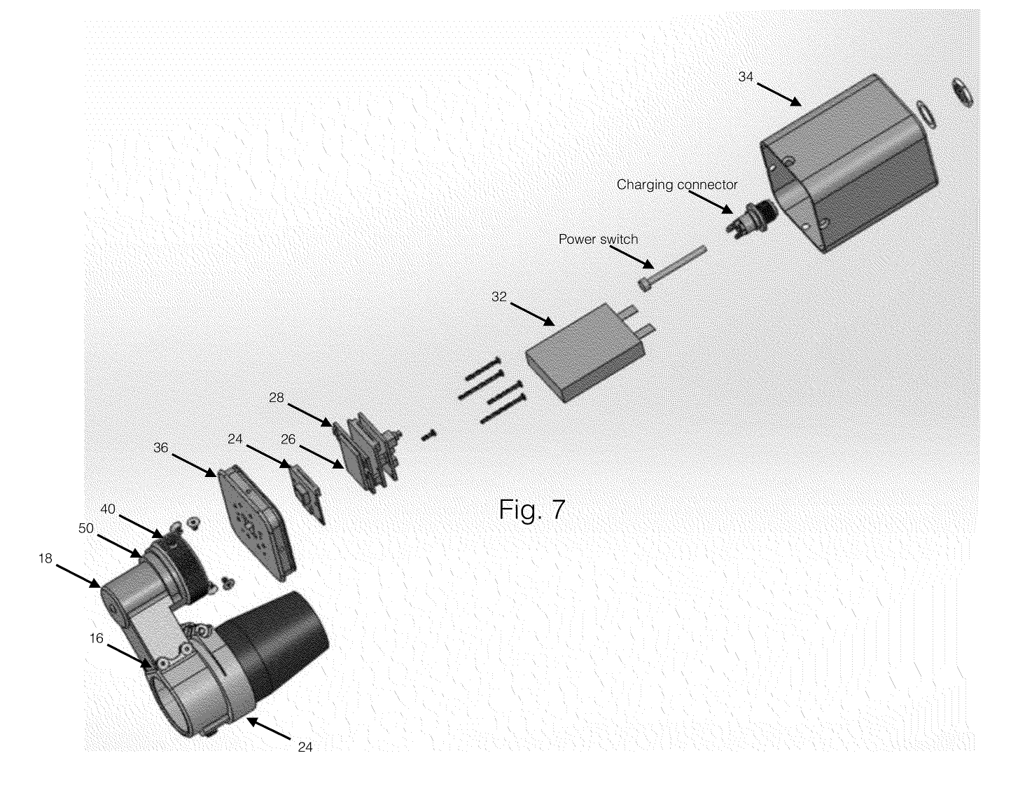

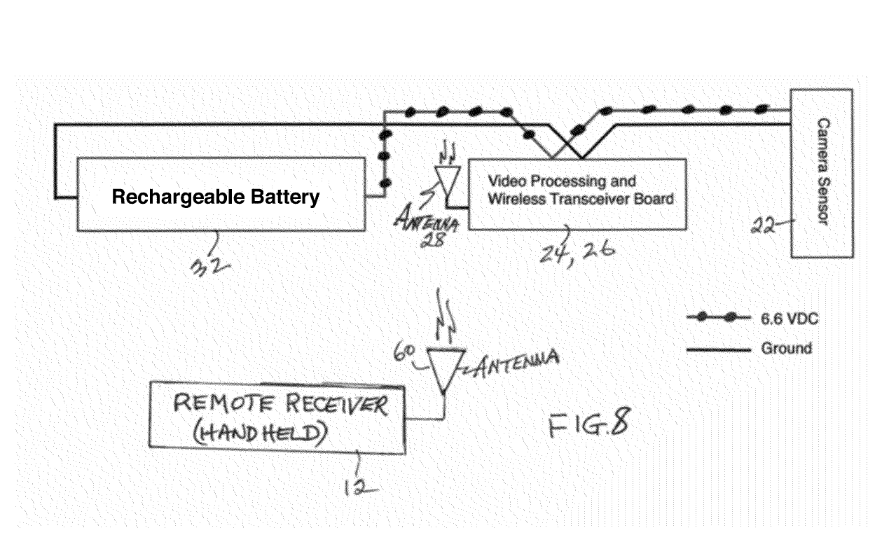

FIG. 7 shows in an exploded view the telescopic image capture device 20.

FIG. 8 shows in a schematic diagram a block diagram of the telescopic image capture device 20 and the hand-held device as a remote receiver communicating with telescopic image capture device 20 via RF wireless transmission via internal antennae.

The an optical relay system consists of a remote telescopic image capture device 20 (shown in FIGS. 3-7) that can be attached or mounted to one or multiple telescopic sights 10, see FIG. 1. The device 20 can be attached to either a weapon mounted or a non-weapon mounted telescopic sight 10. The telescopic image 15 is transmitted to a remote hand-held device 12, which can be a cell phone that enables the viewer of the hand-held device 12 to see the image 15 as it is being viewed through the telescopic device 10.

The telescopic image capture device 20 is mounted on the viewing end of the telescopic device 10 by means of a detachable clamp in the form of a collar fastener 14 (FIGS. 3-6). The telescopic image capture device 20 allows for normal operations of view through the telescopic sight 10, but captures the image 15 by turning prisms 16, 18 that feed the image to an optical sensor 22. The image is transferred from the optical sensor 22 to a video image processor 24, and then transmitted via an RF wireless transceiver 26. The wireless transceiver 26 wirelessly transmits the video transmission to a remote handheld device 12 where the image 15 is displayed.

The telescopic image capture device 20 is run on an internal rechargeable battery housed in the main enclosure 34. The video image processor 24 is mounted on a printed circuit board in the RF transceiver 26 contained in the main housing 34, also mounted to the camera housing 36. An internal antenna 28 is also mounted in the housing 34 and coupled to the RF transceiver 26. Camera housing 36 contains the camera sensor 22 suitability framed on a printed circuit board and coupled to the video image processor 24. The camera housing 36 is controlled by lens focusing ring 40.

As noted above, the mounting and coupling of the remote telescopic image capture device 20 is accomplished by a metal coupler 14 that mounts over the eyepiece of the telescopic sight 10 as seen in FIG. 3-5.

The attachment and adjustment instructions for the remote telescopic image capture device 20 are as follows. First, a lever on collar 14 is loosened to assure slip fit on eyepiece of sight 10. Next, the collar is slid onto the eyepiece. Then, the camera is positioned in the desired “clock” position, and the lever is tightened to assure a snug fit on the eyepiece of the viewing sight.

Next, the focusing/leveling of the video occur. The viewing sight is focused on a distant target with the system powered up both for the remote telescopic image capture device 20 and the hand-held device 12 and the video on the hand-held device is observed. Video focus is adjusted by turning a small coaxial ring 50 on the camera body 36.

If the video image is not level, a large coaxial ring 40 is loosened and the camera body 36 is rotated until image 15 is level. The large ring 40 is tightened.

The remote telescopic image capture device 20 is powered by an internal rechargeable battery 32 which is actuated by a single mechanical switch. The controls of the remote telescopic image capture device 20 are manipulated by a dedicated Android or Apple iOS application. The electrical schematic and/or block diagram is shown in FIG. 8. As shown, battery 32 in housing 34 (see FIG. 7) is connected to power the camera sensor 22 in the main housing 34 and the video processing and wireless transceiver boards 24, 26 located in the housing 36 (see FIG. 7). The output of the video processing board is fed to the wireless transceiver board and broadcast via an antenna 28. The broadcast signal is picked up by the antenna 60 in the hand-held remote receiver 12, suitably processed and the resulting image 15 displayed on the screen of the hand-held remote receiver 12.

What is claimed is:

1. An optical relay system comprising a remote telescopic image capture device for mounting on at least one telescopic sight, weapon mounted or non-weapon mounted; said telescopic image capture device splitting off the image viewed through said sight without disrupting the view through the sight, a camera sensor to convert the split off viewed image into a corresponding electrical signal, an image processor to condition the electrical signal for the transmission via RF, a RF transceiver to transmit the conditioned electrical signal wirelessly, and a remote hand-held device including a display for receiving the transmitted signal, processing it to reconstruct the viewed image and displaying the split off viewed image on the display of the hand-held device to show what is being viewed through the telescopic sight.

2. A method for capturing a telescopic image and viewing remotely comprising the steps of mounting a remote telescopic image capture device on at least one telescopic sight, weapon mounted or non-weapon mounted; splitting off the image viewed through said sight by said telescopic image capture device without disrupting the view through the sight, converting the split off viewed image into a corresponding electrical signal, image processing the corresponding electrical signal, transmitting the image processed electrical signal wirelessly, remotely receiving the transmitted signal by a hand-held device including a display, processing the received transmitted signal to reconstruct the split off viewed image, and displaying the split off viewed image on the display of the hand-held device to show what is being viewed through the telescopic sight.
